(19) United States
(12) Patent Application Publication
(10) Pub. No.: US 2025/0037206 A1
(43) Pub. Date: Jan. 30, 2025

(54) GLOBAL DATA ENHANCEMENT THROUGH LOCAL DATA INTEGRATION

(71) Applicant: International Business Machines Corporation, Armonk, NY (US)

(72) Inventors: Annap Derebail, Smyrna, GA (US); Irina Saburova, New York, NY (US); Thomas Edward Creamer, Boca Raton, FL (US); Sumit Patel, Scottsdale, AZ (US)

(73) Assignee: International Business Machines Corporation, Armonk, NY (US)

(21) Appl. No.: 18/227,678

(22) Filed: Jul. 28, 2023

(51) Int. Cl. G06Q 40/08; G06Q 30/0204

(52) U.S. Cl. CPC G06Q 40/08; G06Q 30/0205

(57) ABSTRACT

An embodiment aggregates a plurality of global data sources and a plurality of local data sources. The embodiment determines, responsive to a user input on an interactive worksheet, a recommended use case. The embodiment determines, based on the recommended use case and based on the plurality of global data sources and the plurality of local data sources, a recommendation for the at least one local data source in the plurality of local data sources. The embodiment update, responsive to a user acceptance of the recommendation, the interactive worksheet based on the at least one local data source.

### BACKGROUND

The present invention relates generally to data analysis. More particularly, the present invention relates to a method, system, and computer program for global data enhancement through local data integration.

The process of data aggregation plays a crucial role in a plethora of sectors, with notable applications in industries such as insurance, real estate, and finance, among others. Data aggregation is a systematic procedure that involves collecting and combining data from diverse sources. The aggregated data can then be analyzed and interpreted to extract useful insights, thereby facilitating more informed decision-making processes and enabling more accurate risk assessments. The data compiled can encompass an array of information types, including demographic data, geographical data, behavioral patterns, historical data, and much more.

One approach is global data aggregation, where data is collected and analyzed on a large scale, such as at the level of an entire country or a broad region. This method allows for the creation of generalized models and profiles that reflect average conditions and characteristics of the larger population or area. Such models can offer valuable insights into widespread trends, common risk factors, and average pricing structures, thereby providing a macro-level perspective on various factors that influence decision-making processes, pricing, and risk assessments.

However, global data aggregation might sometimes lack the granularity needed to address specific, localized circumstances. While a country or region-wide perspective can offer a broad understanding, it may inadvertently overlook unique local attributes or anomalies that could significantly affect outcomes. Consequently, relying solely on such generalized data might lead to less precise quotes or risk assessments, as they may not fully account for the variations and nuances present at the local level.

### SUMMARY

The illustrative embodiments provide for global data enhancement through local data integration. An embodiment includes aggregating a plurality of global data sources and a plurality of local data sources. The embodiment also includes determining, responsive to a user input on an interactive worksheet, a recommended use case. The embodiment also includes determining, based on the recommended use case and based on the plurality of global data sources and the plurality of local data sources, a recommendation for the at least one local data source in the plurality of local data sources. The embodiment also includes updating, responsive to a user acceptance of the recommendation, the interactive worksheet based on the at least one local data source. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment.

FIG. 2 depicts a block diagram of an example software integration process in accordance with an illustrative embodiment.

FIG. 3 depicts a block diagram of an example system for enhancing global data in accordance with an illustrative embodiment.

FIG. 4 depicts a block diagram of an example system for enhancing global data in accordance with an illustrative embodiment.

FIG. 5 depicts a block diagram of an example process for enhancing global data in accordance with an illustrative embodiment.

FIG. 6 depicts a block diagram of an example process for enhancing global data through local data integration in accordance with an illustrative embodiment.

### DETAILED DESCRIPTION

The process of data aggregation is vital across many sectors, including but not limited to insurance, real estate, and finance. This process involves the gathering of information from various sources to provide a broad view, facilitating informed decisions and precise risk assessments. Currently, many organizations rely heavily on global data aggregation, such as country or region-wide data, which offers a generalized perspective on various factors that influence pricing and risk.

However, while global data aggregation provides a foundational understanding of risks and costs, it may overlook certain specific localized factors. These factors can offer a more granular insight into a customer's situation or the nuances of a particular transaction. For example, in a neighborhood with significantly different migration, population mobility, or employment rates compared to the national average, or a region with distinct weather patterns, local data can offer valuable additional context that may drastically influence risk assessment. Augmenting global data aggregation with local data can therefore provide more accurate and personalized quotes and risk assessments. This may involve integrating data from local sources and processing it alongside global data to form a more comprehensive and precise understanding of a situation. The combination of global and local data may offer a multi-level perspective, enabling organizations to better tailor their services to individual circumstances, potentially improving customer satisfaction and organizational efficiency.

There may also be a need to address the exigent needs of both a client service and a client. For example, a client service under consideration may encompass various tasks, such as the generation of new quotes, policy renewals, and expediting the claim process. There may be a need to expedite the claim process may be particularly vital, whether the need arises before or after a first notice of loss (FNOL) in the context of insurance. Thus, there may be a need to facilitate these services more rapidly, reducing the time taken from the initiation of a service to the delivery of value, to thereby increase overall customer satisfaction and promoting a more efficient business operation.

The present disclosure addresses the deficiencies described above by providing a process (as well as a system, method, machine-readable medium, etc.) that combines global data aggregation with local data aggregation. This approach enhances the precision of quotes and risk assessments by offering a more granular and contextual understanding of specific situations. By considering localized attributes and variations in conjunction with broad-scale data, the proposed process allows for a comprehensive multi-level perspective that better reflects both widespread trends and unique local factors. This facilitates more tailored decision-making, ultimately improving the accuracy of pricing structures and risk profiles across various sectors, including but not limited to insurance, real estate, and finance.

An “agent,” as used herein, may refer to an individual or entity that acts on behalf of another individual or entity. In the context of business, for example, agents may represent companies or clients in various transactions, providing expert advice, handling negotiations, or performing specific tasks as needed. The precise role of an agent can vary widely depending on the field and the nature of their responsibilities. Examples include insurance agents, real estate agents, construction agents, mortgage agents, travel agents, and transportation agents.

A “client,” as used herein, may refer to an individual, group, or entity seeking to or currently retaining the services of an agent. For example, a client may be an individual seeking or currently holding an insurance policy or similar services. This could range from an individual seeking home or auto insurance, a company looking for business insurance, or a property owner requiring real estate insurance. The client interacts with an agent or a system to obtain, modify, or renew insurance services. The system in discussion seeks to augment the data relating to the client's profile by combining both country-wide and local data to generate a more precise quote and risk assessment. This ultimately helps in tailoring the services to the client's specific needs, considering their unique circumstances influenced by their location attributes such as country, region, municipality, and/or neighborhood.

Illustrative embodiments include enhancing global data with local data using a global data enhancing engine. “Global data,” as used herein, may refer to general data with broad applicability in an industry, such as insurance, real estate, and finance. For example, an insurance business may use country-wide global data to calculate risk profiles and determine pricing or premiums. Global data may encompass a wide range of factors, including demographic details, geographical location, financial history, and various other elements, which may for instance affect the probability of a claim or the valuation of a property or service. “Local data,” as used herein, may refer to granular information about specific local conditions, such as migration rates, population mobility data, employment data, or weather patterns in a specific area. By combining local data with global data, a user may receive a more comprehensive and precise view of a client's situation within a combined data pool, ranging from country and region to municipality and neighborhood. This level of detail may, for example, dramatically improve the accuracy of risk profiles and insurance quotes. A “global data enhancing engine,” as used herein, may refer to a computational system or software designed to integrate local data into global data. This engine may be capable of synthesizing, comparing, and/or amalgamating information from both data types to provide more precise and detailed insights. The process might involve one or more algorithms, machine learning techniques, or other computational methods to analyze patterns, discern trends, and generate improved data-driven predictions or decisions.

Illustrative embodiments include aggregating a plurality of global data sources. A “global data source,” as used herein, may refer to one or more databases, repositories, or feeds that provide access to global data. For example, a global data source could be a centralized database that houses country-wide demographic information, statistical data on international weather patterns, or high-level employment rates.

In some embodiments, a global data source may include at least one of a national-level data source and a state-level data source. These sources may encompass vast databases and information repositories that provide a broad overview of demographic, economic, or other sector-specific factors at a country or state level. For instance, a national-level data source might contain census data, national weather reports, or country-wide employment rates. Similarly, a state-level source might provide data about state-wide housing markets, regional weather patterns, or state-specific economic indicators. These sources offer valuable macroscopic insights that can be crucial for industries like insurance, real estate, or finance.

The process of aggregating a plurality of global data sources might involve the systematic collection, organization, and integration of data from multiple sources that provide broad, macroscopic information. These global data sources may span numerous geographical regions, industries, or thematic areas. Such aggregation could employ techniques such as data extraction through APIs, direct database access, or data scraping methods. It may also require data cleaning and standardization procedures to ensure the data's integrity and compatibility. Additionally, this aggregation might entail putting in place security measures to safeguard sensitive information and maintain data privacy compliance. The assembled data may then be stored, ready to be analyzed and used for various purposes such as predicting industry trends or making risk assessments.

Illustrative embodiments include aggregating a plurality of local data sources. A “local data source,” as used herein, may refer to one or more databases, records, or feeds that provide access to local data. For example, a local data source could be local government records, a neighborhood-level weather station, a community forum, or social media feeds specific to a particular area, each of which may provide valuable data about the immediate conditions of that specific locale.

In some embodiments, a local data source may include at least one of a city-level data source, a community-level data source, and a street-level data source. These sources may focus on granular, hyper-local information. For example, a city-level data source might contain information about local housing markets, city-specific employment rates, or municipal economic data. A community-level source could include data from community forums, local weather stations, or community-specific demographic data. At the most granular level, a street-level data source might provide highly specific data, such as local traffic patterns, street-specific employment reports, or data from local IoT devices. Such local data sources may contribute to a more detailed and context-aware understanding of conditions, enhancing the precision of risk assessments, pricing calculations, and other data-driven processes.

Aggregating a plurality of local data sources may involve gathering and consolidating specific, granular data from numerous sources that focus on local conditions. This may include local government databases, community forums, social media feeds, or any other repositories that provide localized information. The data collection process from these sources might require tailored methods to handle the specific nature and structure of local data. Following data extraction, similar cleaning, standardizing, and securing procedures may be applied to ensure the data's reliability and safety. This consolidated local data set can offer insights into local trends and conditions, allowing for more context-aware decision-making.

Illustrative embodiments include generating a local insight. A “local insights,” as used herein, may refer to data reflecting conditions and circumstances at a local level, such as a community or street level. This data may include a variety of details, from employment rates to weather patterns, and population density. Generating these local insights may involve integrating and processing local data within the global data, enabling it for example to complement the broader, country-wide data with specific, local attributes. For instance, the system may be designed to analyze weather safety rates at a street level, rather than simply relying on the general weather data for an entire city or region. This approach may allow the system, for example, to provide more accurate and personalized quotes by factoring in specific local conditions that may significantly influence risk and pricing.

Illustrative embodiments include performing real-time local data processing. “Real-time local data processing.” as used herein, may refer to the real-time analysis of data within a local environment, as opposed to waiting for a global centralized data system. This might involve configuring the system to directly access and process data from local data sources, allowing for example a user to quickly understand the full picture of insurance risk without significant delays. For instance, the system could be designed to connect directly to local databases or data sources, efficiently processing data without relying on external processing engines. This approach may provide a user with more options for pricing and enable them to deliver results faster, leading to improved client satisfaction.

Illustrative embodiments include presenting an interactive worksheet to a user. An “interactive worksheet,” as used herein, may refer to a digitally available, dynamic tool designed to facilitate user input and data processing. For instance, the interactive worksheet may be hosted on a web application, accessible on multiple devices. It may have interactive elements such as dropdown menus, sliders, or input fields for the user to define parameters, input data, or specify conditions. For instance, the interactive worksheet may contain fields where an agent can input client details, dropdown menus to select insurance types (home, auto, business, etc.), or sliders to adjust coverage amounts. The dynamic nature of the interactive worksheet may allow it to adjust real-time based on the user's input, pre-set algorithms, or selected data sources.

Illustrative embodiments include determining a recommended use case. A “use case,” as used herein, may refer to a specific situation or scenario for which an interactive worksheet is used. Determining a recommended use case may involve applying one or more algorithms, such as machine learning algorithms or predictive analytics, to analyze the user input data and the available data sources, including global and local. Based on this analysis, the system could identify patterns, trends, or correlations within the data that align with a particular use case. For instance, if an insurance agent inputs data about a client living in a region prone to wildfires, the system might recommend a use case centered on providing a fire risk assessment.

In some embodiments, the recommended use case may be determined responsive to a user input on an interactive worksheet. For instance, if a user specifies a focus on flood insurance, the interactive worksheet may analyze this input against available data sources and suggest a use case that focuses on analyzing and optimizing for flood risk.

Illustrative embodiments include determining a recommendation for at least one local data source in the plurality of local data sources. The recommendation process could be an algorithmic comparison and scoring of the local data sources based on their relevance, accuracy, granularity, and timeliness, among other factors. For example, if the agent is working on generating a quote for a homeowner's insurance policy, the system might recommend local data sources that provide detailed information about the client's neighborhood, such as local weather safety statistics, flood zone maps, or local fire department reports.

In some embodiments, a recommendation for at least one local data source may be based on the recommended use case. For instance, if the recommended use case involves assessing flood risk for a specific client, the system may suggest local data sources that provide detailed, area-specific data about flood history, local terrain and soil types, or local rainfall patterns.

Further, in some embodiments, a recommendation for at least one local data source may be based on the plurality of global data sources and the plurality of local data sources. This process may involve the system using one or more algorithms that weighs the breadth of information available from both global and local data sources, and determining which local data source could provide the best supplemental information to the global data. For example, if the global data sources provide broad data about fires incidences, and the use case involves studying the fire risk of a particular property, the system might recommend a local database of recent fire incidences as a suitable local data source.

Illustrative embodiments include presenting, responsive to a user decline of the recommendation, to the user a list of local data sources in the plurality of local data sources. This could be implemented as a pop-up or a side-panel in the user interface, displaying a list of alternative local data sources with descriptions, data source reliability scores, and previews of the data, among other information. For instance, if an insurance agent declines the initially recommended a local weather database, the system could display a list of other local weather databases, local weather reports, or neighborhood watch records.

Illustrative embodiments include updating, responsive to a user selection of a local data source in the list of local data sources, the interactive worksheet based on the selected local data source. This could involve dynamically loading the selected data into the interactive worksheet, adjusting visualizations, modifying existing metrics or creating new ones based on the newly incorporated data. For instance, if an insurance agent selects a local flood zone map as a data source, the worksheet could dynamically load this map data, adjust risk assessment calculations, and create a new metric that calculates flood risk based on this data.

Illustrative embodiments include updating the interactive worksheet based on the at least one local data source. Once the data from the local data source is incorporated, the worksheet may undergo updates to better reflect the new data source's impact. For example, if the agent agrees to incorporate a local weather database, the worksheet might display historical weather patterns for the client's location and adjust the client's risk score accordingly.

In some embodiments, updating the interactive worksheet based on the at least one local data source may be responsive to a user acceptance of the recommendation. Upon a user's agreement to the recommended local data source, the interactive worksheet might then be adjusted to incorporate this source. This process could involve a variety of updates, such as modifying data visualizations to include new data from the accepted source, recalculating metrics to reflect the inclusion of the new data, or adding new data points or segments based on the newly accepted local data source.

In some embodiments, updating the interactive worksheet includes updating at least one input field in the interactive worksheet. This process could involve adding new fields to accommodate data from the accepted local source, adjusting existing fields to display updated calculations, or modifying field properties based on the characteristics of the newly incorporated data. For instance, if a local data source is selected that provides information on the client's proximity to a fire station, a new input field might be added to the worksheet, asking for the exact distance between the client's residence and the nearest fire station. This information could then feed into the system's calculations, further refining the precision of the insurance quote or risk assessment.

Illustrative embodiments include presenting a client profile. A “client profile,” as used herein, may refer to a visual representation of a client's specific circumstances, such as risk factors and needs. This profile may be constructed from a variety of data points including personal information (like age, occupation, and lifestyle habits), asset-related details (like the value and condition of a home or vehicle), and risk-related factors (such as driving history for auto insurance, or local weather safety rates for home insurance).

Illustrative embodiments include presenting a client profile augmentation recommendation. This process could involve displaying a graphic user interface (GUI) that allows a user to provide necessary information and suggests additional data that could enhance a client profile. For example, the system could be designed to recommend that clients provide information about recent home renovations when applying for home insurance, as this could significantly influence the pricing and risk assessment. Additionally or alternatively, the system may allow the user to select sources of local data, such as one or more databases or types of data desired to be used. This feature may improve the user experience and allow agents to generate more accurate and personalized quotes.

Illustrative embodiments include generating an augmented client profile. An “augmented client profile,” as used herein, may refer to a visual representation of a client incorporating global data and local data. For example, an augmented client profile in the context of insurance may be an enhanced representation of a client's risk profile, incorporating both broad, country-wide data, and detailed, local data. This process may involve configuring the system to combine these two types of data, thus providing a more comprehensive and precise view of a client's risk. The system could be designed, for instance, to overlay local data (like specific weather patterns or infrastructure conditions) onto the broader, country-wide data typically used for risk assessments and pricing calculations. By presenting an augmented quote profile, the system can offer a more nuanced and accurate view of a client's situation, allowing for better-informed decision-making by both agents and clients.

In some embodiments, a client profile may be augmented based on a local data source selected by a user. In such cases, the selection of specific local data may influence the level of detail and precision within a client's profile. For instance, within the insurance sector, an agent may choose to utilize a local weather database when compiling a client profile for home insurance. In this scenario, the system can incorporate this local data into the existing client profile, providing a more granular understanding of the client's potential risk factors. This might involve adjusting the client's risk score based on the relative weather safety of their neighborhood, or presenting specific suggestions for home security enhancements based on local weather patterns. By enabling user selection of local data sources, the system may offer agents and clients greater control and customization capabilities, thus facilitating more accurate and personalized risk assessments and insurance quotes.

In some embodiments, an augmented client profile may be generated responsive to a user input on an updated interactive worksheet. In this context, the interactive worksheet might have been updated with new information derived from a selected local data source, or with user-provided data such as new lifestyle habits or recent home renovations. Subsequently, the system can process this updated information to generate an augmented client profile. For example, if a client were to input new information about installing a high-end security system in their home, the system could utilize this data to adjust the client's risk score and update their home insurance quote accordingly. Similarly, if an agent were to select a local weather database as a data source, the system could incorporate localized weather pattern data into the client's profile, possibly adjusting the client's risk score based on their location's susceptibility to severe weather events. This responsive augmentation of client profiles may allow the system to continually update and refine its assessments, ensuring that risk profiles and insurance quotes remain accurate and up to date.

In some embodiments, the augmented client profile may be based on user-provided information. This information could range from basic personal details, such as the client's age, occupation, and lifestyle habits, to more specific asset-related details, such as the value and condition of a home or vehicle, or a history of previous insurance claims. The user-provided information may also include specifics about the client's location, down to the neighborhood, street, or a particular property. By incorporating this user-provided data into the client profile, the system can ensure that the client's unique circumstances and needs are accurately represented, leading to more personalized and precise outcomes, such as quotes and risk assessments.

Additionally and alternatively, the augmented client profile may be based on selected data sources. These sources could include a variety of external databases, local data sources, or any other information source, such as weather patterns and infrastructure conditions, among others. Selected data sources may also include IoT devices, weather stations, and databases containing repair costs, as well as crowdsourced consumer feedback. In some embodiments, the system might integrate this information with the user-provided data to create an augmented client profile. By leveraging these selected data sources, the system can supplement the user-provided information with additional local and global data, further enhancing the accuracy and comprehensiveness of the client's profile, and thereby the precision of quote and risk assessments.

Illustrative embodiments include developing an agent model. An “agent model,” as used herein, may refer to an algorithmic construct or computational model that encapsulates the behavior of one or more agents, such as strategies, tactics, and key success indicators of high-performing agents within a specific system or industry, such as insurance. The agent model may be developed through machine learning processes and data analysis techniques that observe, learn from, and analyze the decision-making patterns, risk assessment strategies, and customer interaction methods of successful agents. The model may capture and abstract these strategies and practices into a form that can be replicated and applied by other agents within the system. It may utilize computational logic, predictive analytics, and pattern recognition techniques to translate the learned behaviors and successful tactics into actionable recommendations. These recommendations can guide less experienced or less effective agents, enhancing their decision-making capabilities and potentially improving their performance.

For example, the system may be configured to learn from strategies and practices of successful agents and use this knowledge to train newer agents. This might involve configuring the system to analyze the actions of successful agents, identify key success factors, and develop models that help newer agents become more effective. For example, the system could be designed to observe and learn from the actions of top-performing agents, identifying important characteristics and strategies that contribute to their success, and sharing these insights with newer agents.

Illustrative embodiments include determining a recommendation for at least one local data source using a machine learning model. This aspect involves integrating machine learning algorithms to not only enhance the precision of risk assessments and pricing models but also to optimize the selection of local data sources based on specific situations. For instance, in the insurance industry, when an agent is compiling a client profile for auto insurance, the system could recommend a local traffic data source based on the client's residence or workplace. This recommendation could be generated by analyzing factors such as the type of insurance required, the client's specific attributes, and the availability of pertinent local data sources. Consequently, the agent model could employ these recommendations to refine the selection of data sources, improving the accuracy and relevance of the data used for risk assessments and insurance quotes.

Illustrative embodiments include training the machine learning model. Training may involve inputting data into the machine learning model so it can learn and improve its recommendations over time. This process may incorporate historical data, simulated scenarios, and real-time feedback to optimize the machine learning model's performance. In the insurance context, for instance, the model could be trained on historical insurance data, such as past claims data, policy renewal patterns, and customer feedback. By recognizing patterns in this data, the model can learn to better predict which local data sources will be most relevant for particular clients or situations, thus continuously refining its recommendations.

In some embodiments, the machine learning model may receive, responsive to the user accepting the recommendation, a positive feedback. This feedback loop may allow the model to learn and adapt from each interaction, improving its future recommendations. For instance, if an agent accepts the model's recommendation to use a specific local data source (such as a weather database for home insurance risk assessment), the model can register this as positive feedback. This feedback can then be incorporated into the model's learning process, reinforcing the decision-making pattern that led to the successful recommendation.

Conversely, in some embodiments, the machine learning may receive, responsive to the user declining the recommendation, a negative feedback. If an agent declines a recommendation (for instance, choosing not to use a suggested local weather database for a client's auto insurance profile), this decision can be registered as negative feedback. This feedback can signal to the machine learning model that the declined recommendation was not useful or relevant in that particular context or use case. This feedback is essential for the model's learning process, helping it to refine its understanding of what constitutes a relevant recommendation and improving its ability to provide valuable suggestions in the future.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), crasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The process software for global data enhancement through local data integration is integrated into a client, server and network environment, by providing for the process software to coexist with applications, operating systems and network operating systems software and then installing the process software on the clients and servers in the environment where the process software will function.

The integration process identifies any software on the clients and servers, including the network operating system where the process software will be deployed, that are required by the process software or that work in conjunction with the process software. This includes software in the network operating system that enhances a basic operating system by adding networking features. The software applications and version numbers will be identified and compared to the list of software applications and version numbers that have been tested to work with the process software. Those software applications that are missing or that do not match the correct version will be updated with those having the correct version numbers. Program instructions that pass parameters from the process software to the software applications will be checked to ensure the parameter lists match the parameter lists required by the process software. Conversely, parameters passed by the software applications to the process software will be checked to ensure the parameters match the parameters required by the process software. The client and server operating systems, including the network operating systems, will be identified and compared to the list of operating systems, version numbers and network software that have been tested to work with the process software. Those operating systems, version numbers and network software that do not match the list of tested operating systems and version numbers will be updated on the clients and servers in order to reach the required level.

After ensuring that the software, where the process software is to be deployed, is at the correct version level that has been tested to work with the process software, the integration is completed by installing the process software on the clients and servers.

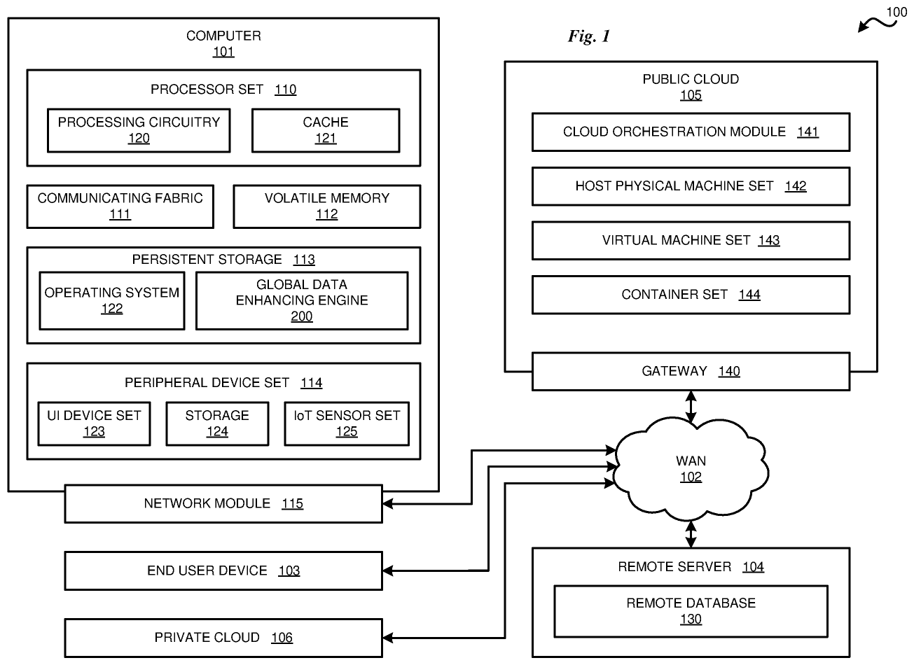

With reference to FIG. 1, this figure depicts a block diagram of a computing environment 100. Computing environment 100 contains an example of an environment for the execution of at least some of the computer code involved in performing the inventive methods, such as global data enhancing engine 200 for global data enhancement through local data integration. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

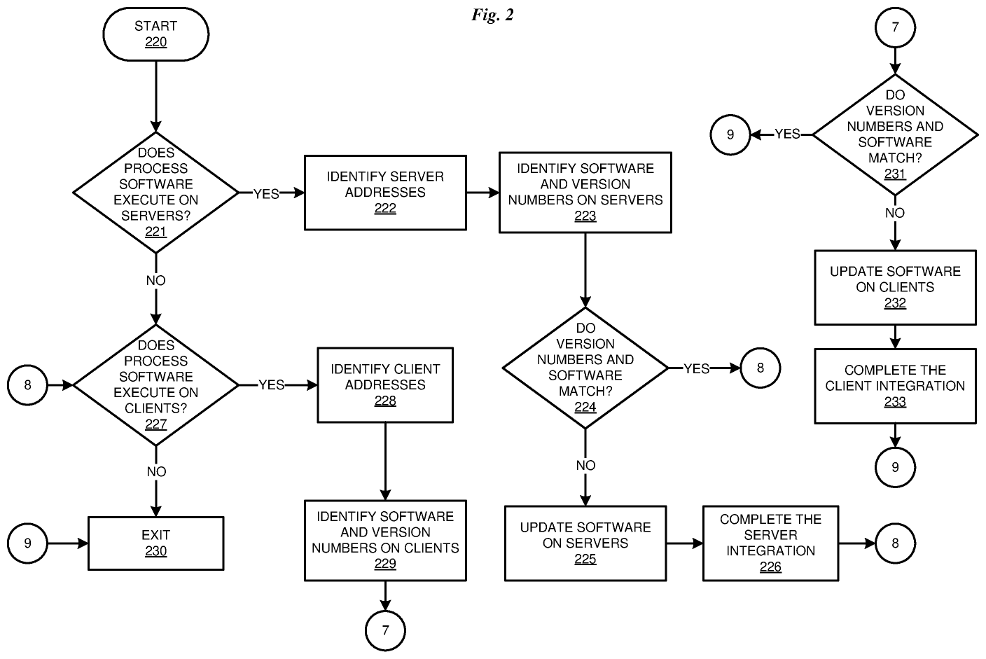

With reference to FIG. 2, this figure depicts a block diagram of an example software integration process, which various illustrative embodiments may implement. Step 220 begins the integration of the process software. An initial step is to determine if there are any process software programs that will execute on a server or servers (221). If this is not the case, then integration proceeds to 227. If this is the case, then the server addresses are identified (222). The servers are checked to see if they contain software that includes the operating system (OS), applications, and network operating systems (NOS), together with their version numbers that have been tested with the process software (223). The servers are also checked to determine if there is any missing software that is required by the process software (223).

A determination is made if the version numbers match the version numbers of OS, applications, and NOS that have been tested with the process software (224). If all of the versions match and there is no missing required software, the integration continues (227).

If one or more of the version numbers do not match, then the unmatched versions are updated on the server or servers with the correct versions (225). Additionally, if there is missing required software, then it is updated on the server or servers (225). The server integration is completed by installing the process software (226).

Step 227 (which follows 221, 224 or 226) determines if there are any programs of the process software that will execute on the clients. If no process software programs execute on the clients, the integration proceeds to 230 and exits. If this not the case, then the client addresses are identified (228).

The clients are checked to see if they contain software that includes the operating system (OS), applications, and network operating systems (NOS), together with their version numbers that have been tested with the process software (229). The clients are also checked to determine if there is any missing software that is required by the process software (229).

A determination is made if the version numbers match the version numbers of OS, applications, and NOS that have been tested with the process software (231). If all of the versions match and there is no missing required software, then the integration proceeds to 230 and exits.

If one or more of the version numbers do not match, then the unmatched versions are updated on the clients with the correct versions 232. In addition, if there is missing required software, then it is updated on the clients 232. The client integration is completed by installing the process software on the clients 233. The integration proceeds to 230 and exits.

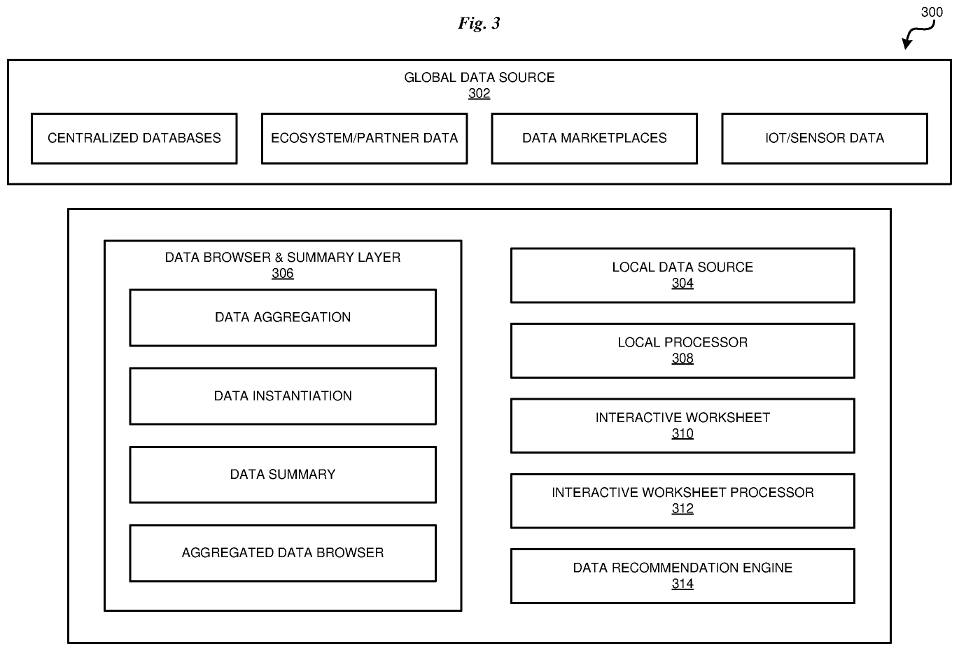

With reference to FIG. 3, this figure depicts a block diagram of an example system 300 for enhancing global data, which various illustrative embodiments may implement. It is to be understood that the system 300 may be implemented as a single unit or as a part of a larger system in which computer-usable program code or instructions implementing the processes may be located for the illustrative embodiments.

In the depicted example, system 300 includes global data source 302, local data source 304, data browser and summary layer 306, local processor 308, interactive worksheet 310, interactive worksheet processor 312, and data recommendation engine 314.

Global data source 302 may comprise one or more internal or external data sources of global data. These could be databases, industry-specific repositories, online resources, or any other data feeds that offer a wide-ranging, macroscopic view of different factors, such as pricing and risk assessment. For example, global data might include country-wide demographic information, statistical data on international weather patterns, global economic indicators, or high-level weather safety rates.

As depicted in the illustration, global data sources may encompass a variety of information sources, each of which may contribute to the understanding of a client's profile. For instance, these global data sources could include one or more centralized databases. These databases could house large amounts of aggregated data, encompassing details from numerous areas. In the context of insurance, for example, a centralized database may provide a broad perspective on the factors influencing insurance risk and pricing.

Global data sources could also incorporate ecosystems or partner data. This could involve data sharing arrangements with partner companies or other organizations, enabling the access to a wealth of additional data, such as historical claim data, demographic information, or other relevant factors that influence, for example, risk assessment and pricing.

Moreover, global data sources may comprise data marketplaces. These marketplaces may be platforms where data providers can sell their data to interested parties. This could include anything from demographic data to detailed reports on specific market segments. offering another resource for information, for example, in comprehensive risk assessment and pricing calculation.

Furthermore, device data such as Internet of Things (IoT) or sensor data could also be part of the global data sources. Devices such as IoT devices and sensors can gather real-time data on a wide range of variables. For instance, in the context of automobile insurance, data from vehicle sensors could provide insights about driving habits, which could then be incorporated into the risk assessment and pricing process. Consequently, the collection of global data from these diverse sources can enhance the comprehensiveness and accuracy of the data aggregation process, leading to more precise risk assessments and quotes.

Local data source 304 may comprise one or more internal or external data sources of local data. This data may be more specific and context-driven compared to its global counterpart. The sources could include a diverse array of databases and feeds, such as local government records, neighborhood-level weather stations, community forums, or social media feeds, as well as data that has been crowdsourced from individuals in a particular area. The precision and granularity offered by the local data sources may provide the system with more precise, context-aware, and ultimately more accurate assessments that reflect the immediate circumstances of the client.

Data browser and summary layer 306 may represent a consolidated view of relevant information. This could include global data, local data, client profiles, and recommendations, among other data points. It may act as an information hub, integrating, organizing, and summarizing vast amounts of diverse data into a streamlined and accessible format. It may thus serve as a front end, providing an intuitive, user-friendly interface for data browsing. It may also serve as the user's gateway to the data aggregation system, offering them the flexibility to navigate through the compiled data, enhancing overall system usability.

The data browser and summary layer may also be configured to facilitate interactions with diverse data sources based on various determining factors, such as user configurations, local regulations, and business requirements. It may be configured to aggregate data, merging information from disparate sources into a unified dataset. Once data is aggregated, the layer may instantiate pertinent information, transforming raw, unstructured data into useful, context-specific forms. This could involve translating raw demographic details into comprehensive client profiles, or restructuring raw insurance claim data into identifiable cases. In addition, it may be equipped to summarize data, transforming vast volumes of information into condensed, accessible overviews, enabling users to make informed decisions rapidly.

Moreover, as shown in the illustrative embodiment, the data browser and summary layer may consist of multiple modules, each of which may provide distinct functionalities that may contribute to an efficient and comprehensive data aggregation process.

For instance, a data aggregation module could serve as the central hub for collecting data from various sources, both global data and local data (e.g., from global data source 302 or local data source 304). This module might be responsible for pooling together data from diverse inputs, harmonizing the collected information to ensure consistency and compatibility across the dataset. This pooled data may provide the raw material upon which subsequent analyses and assessments can be based.

Next, a data instantiation module could be involved in creating specific instances or objects of the collected data. This module might be crucial in shaping the raw data into meaningful, structured forms suitable for further processing and analysis. For example, it could transform raw demographic information into structured client profiles, or convert raw claim data into specific insurance cases.

Next, a data summary module could be configured to condense collected data into easily understandable, concise summaries. This module might employ various summarization techniques, like data visualization or key metrics calculation, to present a high-level overview of the aggregated data. These summaries could provide valuable insights at a glance, assisting users in making informed decisions.

Lastly, an aggregated data browser module could allow users to navigate through the amassed data conveniently. This module could offer various search and filter options, enabling users to find specific data points or view the data from different angles. This feature could enhance the usability of the data aggregation system, allowing for a more flexible and targeted exploration of the data.

Local processor 308 may be configured to process data from various components of the system, including data browser and summary layer 306, interactive worksheet processor 312, and data recommendation engine 314. This processor may be strategically located close to local data sources for efficient data transmission and processing, minimizing latency, and increasing the speed and responsiveness of the system. In some instances, the local processor may be an edge computer or a local server that is capable of managing high volumes of data in real time.

The local processor might receive global and local data from data browser and summary layer 306. This data could include wide-ranging macroscopic views of different factors from the global data source and more context-specific details from the local data source. Upon receiving this data, local processor 308 may carry out processing tasks such as data cleaning, normalization, or segmentation to prepare the data for subsequent use in the system.

Interactive worksheet processor 312 feeds data into local processor 308 as well. This data could be direct user inputs and insights derived from these inputs. For instance, it could include client-specific data like personal details, asset-related information, and historical data points, all of which may be used for creating a comprehensive client profile. The local processor may process this user-provided information, integrating it with other data to enhance the system's understanding of a client's unique circumstances and requirements.

In addition, local processor 308 could receive data from the data recommendation engine 314. This engine may generate recommendations for local data sources based on an analysis of aggregated data and client profiles. Once these recommendations are processed by local processor 308, they can be fed back into the system, informing updates to the client profile and refining the data aggregation process.

Interactive worksheet 310 may be an electronic client data input form and may be interacted with through any electronic means, such as a browser or application. The interactive worksheet may be used to collect user-provided information, which may represent a wide spectrum of client-specific data, ranging from foundational personal details such as the client's age, occupation, and lifestyle habits, to more targeted asset-related details. These details could include the value and condition of tangible assets like a home or vehicle, and extend to historical data points such as a history of previous insurance claims. The interactive worksheet may be filled out by an agent, client, or a third party. The convenience of the form may allow for effective and efficient data capture.

Interactive worksheet processor 312 may analyze the data from the interactive worksheet 310. It may apply a range of data analysis techniques to the task, interpreting the raw input data, extracting relevant information, identifying potential patterns and correlations, and producing meaningful insights that are then fed into the system for further processing.

For example, in some embodiments, the augmentation of a client profile may be based on user-provided information captured through the interactive worksheet and processed by the interactive worksheet processor. The user-provided data collated through the interactive worksheet may help ensure that the client's unique circumstances and requirements are accurately captured and represented within the system. This may enhance the system's ability to generate outcomes that are tailored to the client's situation, thereby enhancing for instance the precision of quotes and risk assessments.

Data recommendation engine 314 may generate local data source recommendations from aggregated data (e.g., from data browser and summary layer 306), user input, and any other data. It may display local data source recommendations, through data browser and summary layer 306, derived from its analysis of the data sources and the client's profile. It may employ one or more machine learning models, including machine learning models for determining recommendations.

The engine may also receive user input, making it an interactive tool for augmenting and refining a client's profile. This feature of the system could involve displaying a graphic user interface that recommends additional data sources that could enrich the accuracy and completeness of a client profile. As an example, in some embodiments, the data recommendation engine may be configured to allow the user to handpick from available sources of local data sources. The user could select from an array of databases or specific types of data that they would like incorporated into their data analysis. As such, for example, the data recommendation engine may equip agents with the ability to generate more accurate and personalized quotes, contributing towards more nuanced and precise risk assessments and pricing determinations.

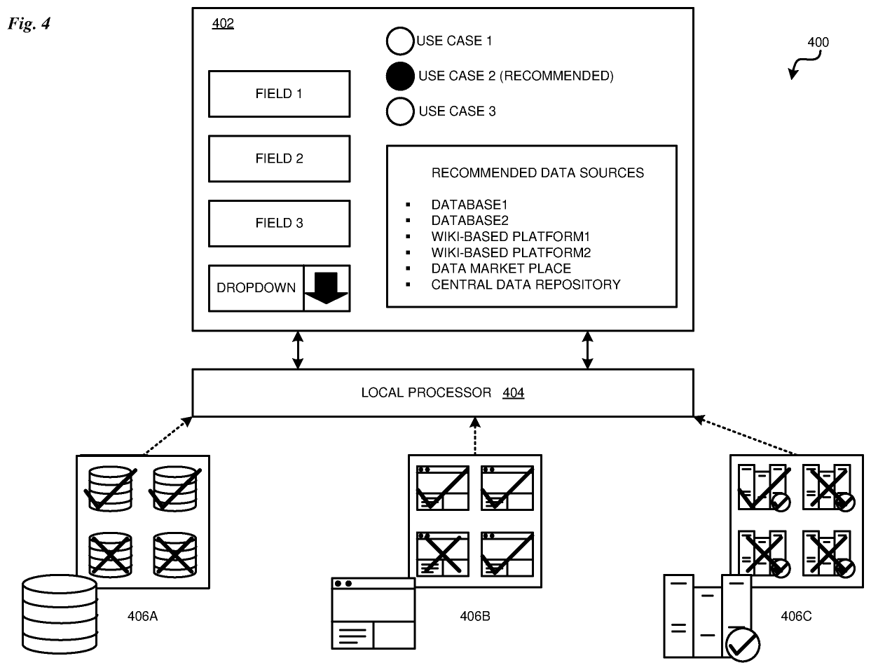

With reference to FIG. 4, this figure depicts a block diagram of an example system 400 for enhancing global data, which various illustrative embodiments may implement. It is to be understood that the system 400 may be implemented as a single unit or as a part of a larger system in which computer-usable program code or instructions implementing the processes may be located for the illustrative embodiments.

In the depicted example, system 400 includes interactive worksheet 402, local processor 404, and data sources 406a, 404b, and 404c. As shown, interactive worksheet 402 may contain recommended use cases tailored to various applications such as insurance intake, real estate, mortgages, and more. This adaptability makes it a dynamic version of existing interactive worksheets, designed to cater to a wide range of needs.

It may also take a proactive approach towards guiding users, offering recommendations on potential data sources that could supplement and enrich the input. For instance, as illustrated, the interactive worksheet may suggest accessing a first database which may contain information relevant to a user-input field, or it may suggest accessing a second database which may house data regarding average costs. It might also recommend leveraging a first wiki-based platform which may include resources that describe risk attributes, or a second wiki-based platform which may provide detailed local attributes. Further, it may propose the utilization of other data sources, such as a data marketplace or a central data repository, both of which may offer additional value data that could enrich the client profile.

Apart from its data recommendation functionality, the interactive worksheet may also include fields for user input. These fields enable users to insert necessary client data, creating a dynamic, adaptable environment that accommodates a variety of client situations. By providing guidance on data sourcing while simultaneously allowing personalized client input, the interactive worksheet may position itself as an essential tool in the data collection and processing landscape.

Local processor 404 may be configured to process and integrate information collected from various sources. It may receive data inputs from the interactive worksheet 402 and combine this with user-selected sources of data from data sources 406a, 406b, and 406c. This aggregation of data from diverse sources may facilitate a comprehensive analysis. In the depicted embodiment, the selection of a data source is symbolized by a check, indicating that a specific data resource has been activated. In contrast, a cross signifies that a particular data source has not been chosen for inclusion.

Local processor 404 may also aggregate and summarize the most relevant portions of the data sourced from various backends. These backends can include, but are not limited to, databases, wikis, data repositories, marketplaces, etc. By extracting the most pertinent subsets of data, the interactive worksheet processor may optimize the data pool, ensuring that the most significant information is readily available. This function may enable the system to provide the most accurate and relevant results, thereby enhancing overall precision and effectiveness.

In the depicted example, local processor 404 could also comprise a machine learning model, such as an agent model, that is trained through user feedback. This feedback may be obtained when a user either accepts or declines a recommendation provided by the system. The feedback may serve as a learning mechanism that enables the local processor to continually refine and enhance its processing and recommendation capabilities.

For instance, when a user accepts a recommendation, this decision may provide positive reinforcement, indicating that the system has made an accurate and relevant suggestion. Conversely, if a user declines a recommendation, it could signal to the system that the suggestion was not suitable, and there is room for improvement. This negative feedback may then be used to adjust the system's recommendation algorithms, helping to steer future suggestions towards higher relevance and accuracy.

The machine learning model in the local processor, trained through user interactions, may therefore allow the system to dynamically adapt to users' preferences and requirements, leading to a more personalized and engaging user experience. Moreover, the feedback-driven learning process could contribute towards the continual improvement and optimization of the system, leading to more refined and targeted results.

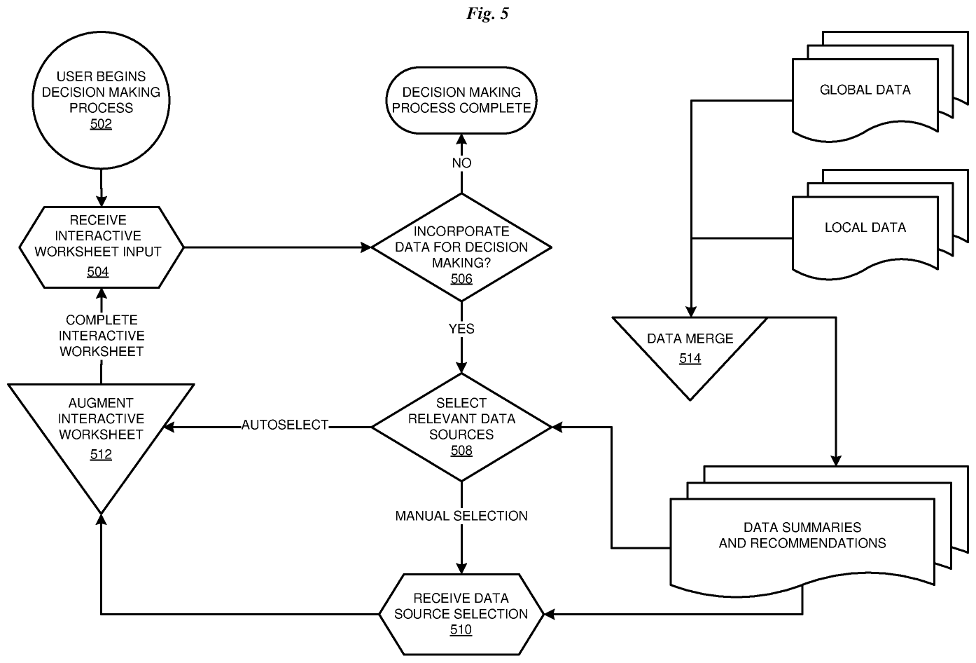

With reference to FIG. 5, this figure depicts a block diagram of an example process for enhancing global data in accordance with an illustrative embodiment 500. The example block diagram of FIG. 5 may be implemented using global data enhancing engine 200 of FIG. 1.

In the illustrative embodiment, at block 502, the user may begin a decision-making process. For instance, the user may seek to make a decision regarding effective generation of quotes and risk assessments in the context of insurance.

At block 504, the process may receive an interactive worksheet input. The interactive worksheet may contain relevant information for the decision-making as well as user input fields, which may range from basic client details to data source preferences. The user's provided input may set conditions for the system, establishing the initial framework for the decision-making process.

At block 506, the process may determine whether to incorporate data for decision-making. This determination may be based on user input (e.g., the user selecting not to incorporate any data) or automatically by the system (e.g., the system recommending not incorporating the data). If the determination is not to incorporate data, the decision-making process concludes. This scenario may indicate that either the provided data lacks relevance or there is no necessity for further decision-making at that moment.

If the process decides to incorporate the data, at block 508, the process selects relevant data sources. Here, the process may recommend relevant data sources, which may be based on the user's preferences and/or the system's algorithms. Additionally and alternatively, the user may select data sources for incorporation into the decision-making process. This data could range from global data to local data, catering to the individual needs of the user.

If the user provides a manual selection, at block 510, the process receives the data source selection. The process may integrate the user-selected data sources into the decision-making framework. This flexibility in source selection empowers users, allowing them to exercise control over the decision-making process.

The system may also provide an automatic selection, at block 512, to augment the interactive worksheet. By leveraging historical data and learned patterns, the system may auto-select the most relevant data subsets based on previous successful use cases, alleviating the burden on the user to manually identify pertinent information.

At block 514, the process may merge data sources (such as global data, localized data, and selected data sources) to generate data summaries and recommendations for future use. By integrating, prioritizing, and/or summarizing the most relevant subsets of data based on the interactive worksheet fields from an aggregate data set, the system may generate comprehensive data summaries and recommendations for future use. This strategy enables it to take into account a rich array of information, from nationally recognized credit scores to locally known insights about a borrower. Consequently, this wealth of integrated data may allow the system to deliver more nuanced and accurate decisions, vastly improving the overall precision and effectiveness of the decision-making process.

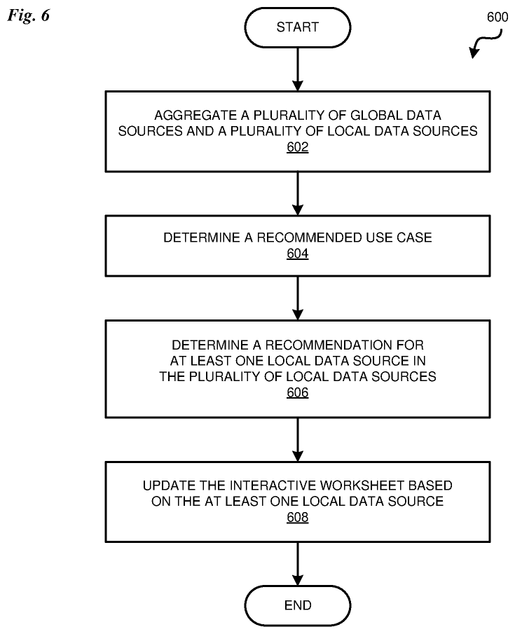

With reference to FIG. 6, this figure depicts a block diagram of an example process for enhancing global data through local data integration in accordance with an illustrative embodiment 600. The example block diagram of FIG. 6 may be implemented using global data enhancing engine 200 of FIG. 1.

In the illustrative embodiment, at block 602, the process may aggregate a plurality of global data sources and a plurality of local data sources. At block 604, the process may determine a recommended use case. At block 606, the process may determine a recommendation for at least one local data source in the plurality of local data sources. At block 608, the process may update the interactive worksheet based on the at least one local data source. It is to be understood that steps may be skipped, modified, or repeated in the illustrative embodiment. Moreover, the order of the blocks shown is not intended to require the blocks to be performed in the order shown, or any particular order.

The following definitions and abbreviations are to be used for the interpretation of the claims and the specification. As used herein, the terms “comprises,” “comprising.” “includes,” “including.” “has,” “having.” “contains” or “containing.” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially.” “approximately.” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
aggregating, by a global data enhancing engine, a plurality of global data sources and a plurality of local data sources;
determining, by the global data enhancing engine, responsive to a user input on an interactive worksheet, a recommended use case;
determining, by the global data enhancing engine, based on the recommended use case and based on the plurality of global data sources and the plurality of local data sources, a recommendation for at least one local data source in the plurality of local data sources; and
updating, by the global data enhancing engine, responsive to a user acceptance of the recommendation, the interactive worksheet based on the at least one local data source.

2. The method of claim 1, wherein updating the interactive worksheet based on the at least one local data source includes updating at least one input field in the interactive worksheet.

3. The method of claim 1, further comprising:
updating, responsive to a second user input on the updated interactive worksheet, a client profile.

4. The method of claim 1, further comprising:
augmenting, based on the at least one local data source, a client profile.

5. The method of claim 4, further comprising:
presenting, responsive to a user decline of the recommendation, to the user a list of local data sources in the plurality of local data sources; and
updating, responsive to a user selection of a local data source in the list of local data sources, the interactive worksheet based on the selected local data source.

6. The method of claim 1, wherein determining the recommendation for the at least one local data source is performed using a machine learning model.

7. The method of claim 6, further comprising:
providing, responsive to the user accepting the recommendation, a positive feedback to the machine learning model; and
providing, responsive to the user declining the recommendation, a negative feedback to the machine learning model.

8. The method of claim 1, further comprising:
wherein the global data source includes at least one of a national-level data source and a state-level data source.

9. The method of claim 1, further comprising:
wherein a local data source in the plurality of local data sources includes at least one of a city-level data source, a community-level data source, and a street-level data source.

10. A computer program product comprising one or more computer readable storage media, and program instructions collectively stored on the one or more computer readable storage media, the program instructions executable by a processor to cause the processor to perform operations comprising:
aggregating, by a global data enhancing engine, a plurality of global data sources and a plurality of local data sources;
determining, by the global data enhancing engine, responsive to a user input on an interactive worksheet, a recommended use case;
determining, by the global data enhancing engine, based on the recommended use case and based on the plurality of global data sources and the plurality of local data sources, a recommendation for at least one local data source in the plurality of local data sources; and
updating, by the global data enhancing engine, responsive to a user acceptance of the recommendation, the interactive worksheet based on the at least one local data source.

11. The computer program product of claim 10, wherein updating the interactive worksheet based on the at least one local data source includes updating at least one input field in the interactive worksheet.

12. The computer program product of claim 10, further comprising:
updating, responsive to a second user input on the updated interactive worksheet, a client profile.

13. The computer program product of claim 10, further comprising:
augmenting, based on the at least one local data source, a client profile.

14. The computer program product of claim 10, wherein determining the recommendation for the at least one local data source is performed using a machine learning model.

15. The computer program product of claim 14, further comprising:
providing, responsive to the user accepting the recommendation, a positive feedback to the machine learning model; and
providing, responsive to the user declining the recommendation, a negative feedback to the machine learning model.

16. A computer system comprising a processor and one or more computer readable storage media, and program instructions collectively stored on the one or more computer readable storage media, the program instructions executable by the processor to cause the processor to perform operations comprising:
aggregating, by a global data enhancing engine, a plurality of global data sources and a plurality of local data sources;
determining, by the global data enhancing engine, responsive to a user input on an interactive worksheet, a recommended use case;
determining, by the global data enhancing engine, based on the recommended use case and based on the plurality of global data sources and the plurality of local data sources, a recommendation for at least one local data source in the plurality of local data sources; and
updating, by the global data enhancing engine, responsive to a user acceptance of the recommendation, the interactive worksheet based on the at least one local data source.

17. The computer system of claim 16, wherein updating the interactive worksheet based on the at least one local data source includes updating at least one input field in the interactive worksheet.

18. The computer system of claim 16, further comprising:
updating, responsive to a second user input on the updated interactive worksheet, a client profile.

19. The computer system of claim 16, wherein determining the recommendation for the at least one local data source is performed using a machine learning model.

20. The computer system of claim 19, further comprising:
providing, responsive to the user accepting the recommendation, a positive feedback to the machine learning model; and
providing, responsive to the user declining the recommendation, a negative feedback to the machine learning model.
